(19) United States
(12) Patent Application Publication
(10) Pub. No.: US 2002/0070855 A1
(43) Pub. Date: Jun. 13, 2002

(54) Radio frequency remote control device and method for locating objects

(76) Inventor: Shih-Ming Hwang, Irvine, CA (US)

Correspondence Address: BACON & THOMAS, PLLC, 625 Slaters Lane, 4th Floor, Alexandria, VA, 22314-1176, US

(21) Appl. No.: 09/732,789

(22) Filed: Dec. 11, 2000

(51) Int. Cl. G08B 1/08; H04Q 7/00; G08B 21/00

(52) U.S. Cl. 340/539; 340/540

(57) ABSTRACT

A method and devices that apply radio frequency remote control device to find objects, the major part of the present invention is a radio frequency remote control device which is mounted at a fixed position. The radio frequency remote control device has an internal timing device, for special purpose users such that the device can make audible and/or visible warning signals to remind the user of the time of medication. By applying the working principle of radio frequency transmitting and receiving function, when the setting time has arrived or the user presses a button, the radio frequency remote control will emit a coded signal according to the receiving instruction. This signal is the received by a receiver. After decoding, if the signal is correct, the warning device in the receiver will emit audible and/or visible signals to allow for the user to locate the object. Thus achieve the convenience of modern life.

The radio frequency remote control is also capable of duplicating the codes of other radio frequency transmitter control device.

### BACKGROUND OF THE INVENTION

1. Field of the Invention

This invention relates to a method and devices that apply radio frequency remote control device to find objects of user's interest. The principle of this invention is to use radio frequency remote control function and a audible/visible warning signal to help user rapidly find the item needed.

2. Description of the Prior Art

For modern people with today's busy lifestyle, one may come home exhausted after a hard-working day, sometimes put his/her personal belongings carelessly on some place and forgot where it was after a while, or one may forgot the location of a house appliance that s/he just used a while ago, thus couldn't find the object when s/he need it urgently, and waste a lot of time to looking for the object s/he need, this not only consume the time but also the search job may turned out to be failed, hence further cause a negative influence to this person's mood; for patients who are in the process of long-term medication in which each dose must be taken on time to control the problem, if the patient can not find the medicine at the scheduled dose time, the delay of medication sometime can cause a unrecoverable tragedy.

In view of above said imperfections and pitfall of modern people's busy lifestyle, after years of constant effort in research for possible improvement, the inventor of this invention has consequently developed and proposed an improved invention pertaining to the subject matter: a method and device apply radio frequency remote control device to find objects.

### SUMMARY OF THE INVENTION

The objective of this invention is to provide a method and device(s) that uses radio frequency remote control device to find object(s). In this invention, a radio frequency transmitter is mounted at a fixed position, while an important house appliance or personal effect (such as first-aid kit, medicine container, remote control, key chain, etc.) is installed with a radio frequency receiver. When the user forgets the location of the above said object s/he need, with the working principle of radio frequency transmitting/receiving property, the user can find the object quickly by the present invention.

Another sub-objective of the present invention is to provide a power saving, long-term functioning, space saving (with miniature size) device and method apply radio frequency remote control device to find objects.

Yet another sub-objective of the present invention is to provide a radio frequency transmitter with an internal timing device for special purpose users. It can be setup as a periodic reminder a patient to remind him/her the time of medication. The device can make audible and visible warning signals when the medication time is approaching. Thereby allowing the patient to find the medicine quickly and take the medicine on time. The above said application describes one advantage of the present invention, which is the method and devices that applies radio frequency remote control device to find objects.

The last sub-objective of the present invention is to provide radio frequency transmitter and radio frequency receiver with low power detection. When the power voltage of the radio frequency transmitter and radio frequency receiver drops below the preset value, the detection circuit will drive the warning device function, reminding the user that the power supply needs to be replaced.

With the above said advantages, the present invention pertains to the method and devices that apply radio frequency remote control device to find objects. It is composed of a radio frequency transmitter and a radio frequency receiver. The transmitter is mounted on at fixed position, and the radio frequency receiver can be installed on articles such as first-aid kits, medicine container, remote control, etc. When a user needs to find any of above said objects, s/he can press the button (labeled with the name of the above said object) on the radio frequency transmitter, to enable the coding signal generator of the said radio frequency transmitter to generate a coded signal. The coded signal is passed to a transmitting device in the transmitter, where the transmitting device will then transmit the coded signal through the transmitter antenna. The coded signal will be received by the receiver antenna of a receiver, decoded and analyzed to see if this signal is a valid signal. When everything is correct, a warning device in the receiver will emit audible with visible signals to allow for the user to locate the object.

### BRIEF DESCRIPTION OF THE DRAWINGS

The drawings disclose an illustrative embodiment of the present invention, which serves to examplify the various advantages and objects hereof, and are as follows:

FIG. 1 depicts a block diagram of the radio frequency transmitter in the present invention that applies radio frequency remote control device to find objects;

FIG. 2A depicts an operation flow diagram of the radio frequency transmitter in the present invention that applies radio frequency remote control device to find objects;

FIG. 2B depicts a power management flow diagram of the radio frequency transmitter in the present invention that applies radio frequency remote control device to find objects;

FIG. 3 depicts a block diagram of the radio frequency receiver in the present invention that applies radio frequency remote control device to find objects;

FIG. 4A depicts an operation flow diagram of the radio frequency receiver in the present invention that applies radio frequency remote control device to find objects;

FIG. 4B depicts a power management detection flow diagram in the radio frequency receiver of the present invention that applies radio frequency remote control device to find objects; and

FIG. 5 depicts an implementation diagram in the present invention that applies radio frequency remote control device to find objects;

[Representation ID of the Major Part]

1 radio frequency transmitter

11 button set

12 power supply device

13 low power detection circuit

14 warning device

15 timing device

16 coding signal generator

17 radio frequency transmitting device

18 radio frequency transmitter antenna

2 radio frequency receiver

21 radio frequency receiver antenna

22 power supply device

23 low power detection circuit

24 receiving device

25 signal decoding device

26 warning device

27 reset key

7 radio frequency remote control device

### DETAILED DESCRIPTION OF THE PREFERRED EMBODIMENT

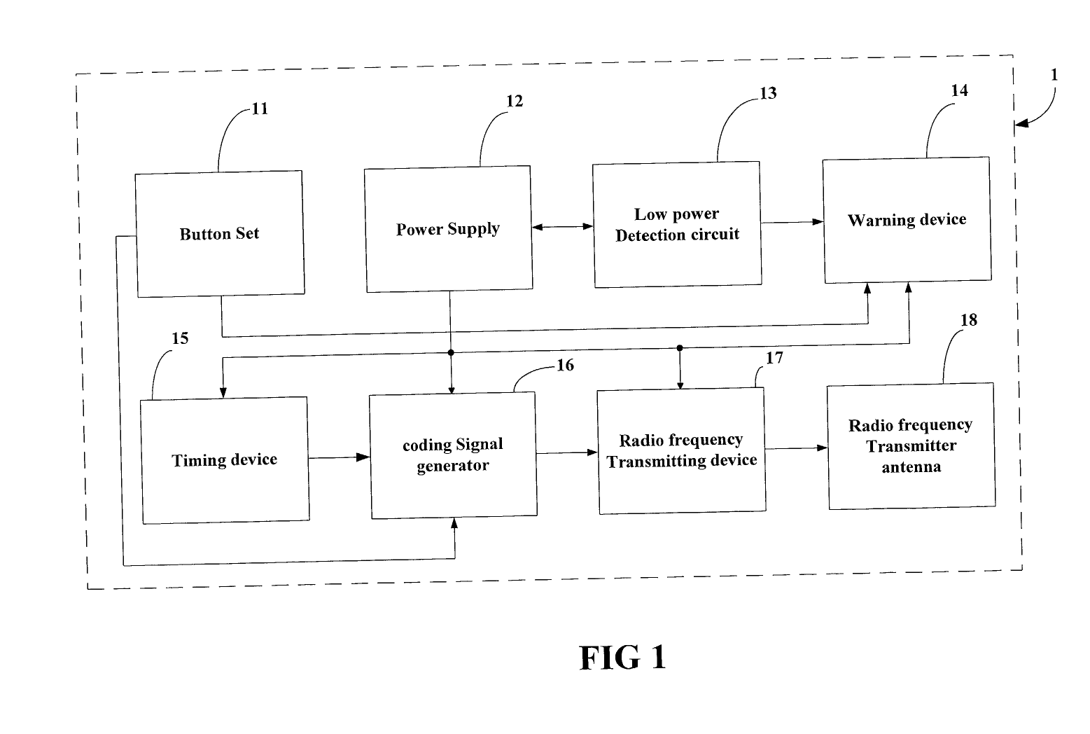

Please refer to FIG. 1 for the block diagram of the transmitter in the present invention that applies radio frequency remote control device to find objects. The transmitter I is mounted at fixed position and is composed of:

a power supply device 12, which provides the necessary power for all other components of the radio frequency transmitter device as to function correctly;

a low power detection circuit 13, which monitors the power supply condition of the radio frequency transmitter device. If the power drops below the preset value, the detection circuit will activate the warning device 14;

a warning device 14, comprised of a audible device used to tell the user that the transmitter is about to run out of power and needs to replaced. Otherwise the transmitting function of the radio frequency transmitter may not work properly;

button set 11, appears on the outside of the radio frequency transmitter device. In addition to control the on/off operation of the warning device 14 and the timing device 15, the button of the button set can be labeled with different name of objects, so the user can find a specific object quickly by pressing the button with the corresponding label on it;

a timing device 15, used for setting up the time;

a coding signal generator 16, which generates a coded signal when the user presses the key or when the preset time expires. The coded signal will be sent to the transmitting device 17 then transmitted through the transmitter antenna 18.

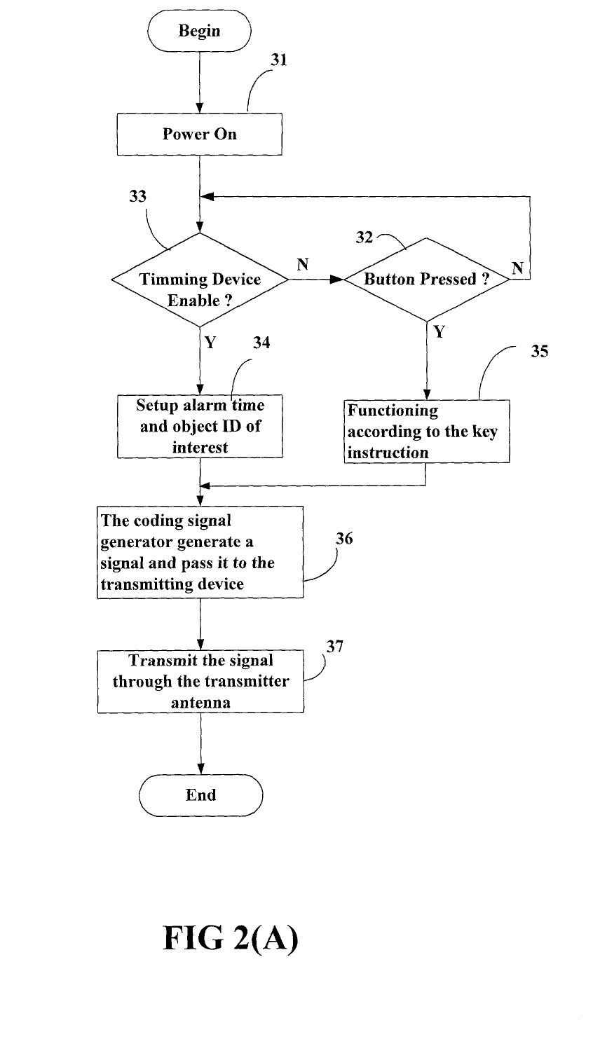

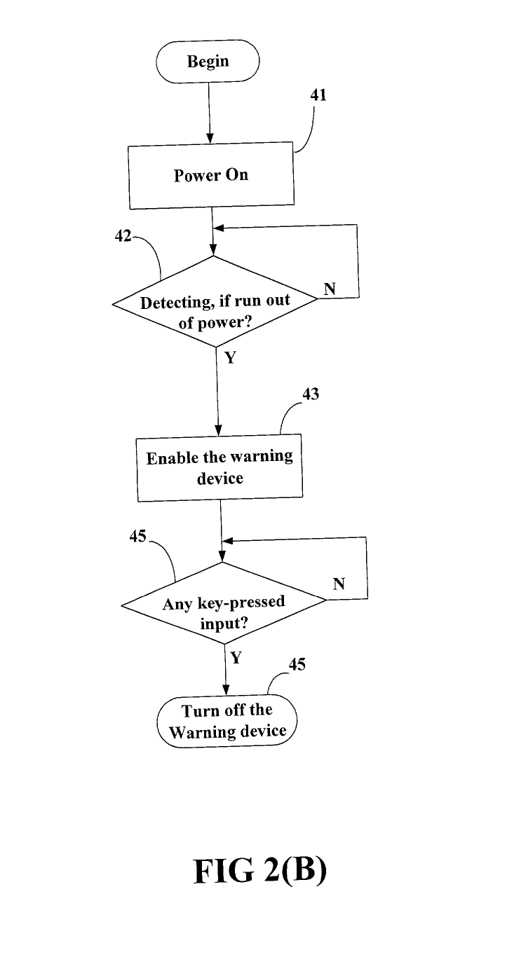

Please refer to FIG. 2A for the operation flow diagram that depicts the transmitter of the present invention, which applies radio frequency remote control device to find objects. When the power supply 31 of the transmitter is on, it will begin to monitor the transmitter. It will decide if it needs to activate the timing device 33, if yes, it will set up the time and the instruction related to the object of the user's interest. When the preset time is reached, a coding signal generator will generate a coded signal according to the said instruction and pass it to the transmitting device 36. The transmitting device will then transmit the coded signal through the transmitter antenna 37. If the transmitter decides not to activate the timing device, the transmitter will decide the key input 32 instruction. The transmitter will keep its normal condition if there is no keys are pressed, if there is a key press input, the coding signal generator will generate a coded signal according to the said instruction 35 and pass it to the transmitting device 36. The transmitting device will then transmit the coded signal through the transmitter antenna 37.

Please refer to FIG. 2B for the power management flow diagram of the transmitter in the present invention that applies radio frequency remote control device to find objects. When the power supply 41 of the transmitter is turned on, the low power detection device will begin to monitor the power level to see if it is lower than the preset value 42. If it isn't, the detection device will continue to monitor the condition of power supply. Otherwise (this voltage is lower than the preset value 42), the low power detection device will enable a warning device to emit a continuous audible and visible signal to remind user that the power supply 43 needs to be replaced. The low power detection device will continue to detect the key-press instruction and continuously emit audible and visible signals for as long as there's no key-press. The warning device 45 will turn off when a key is pressed or new battery is replaced.

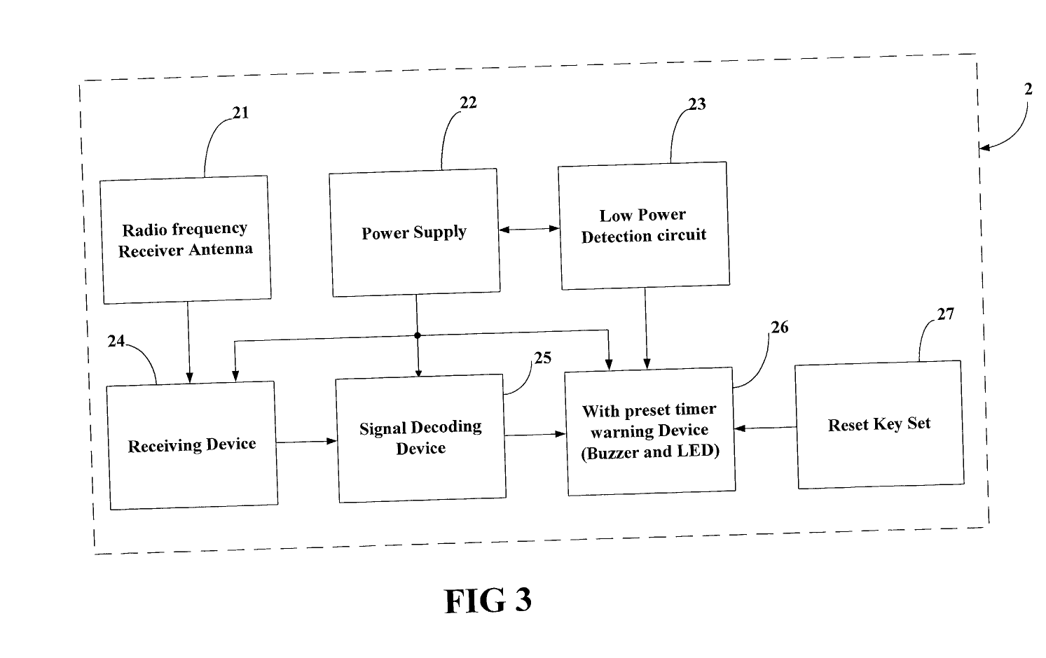

Please refer to FIG. 3 for the block diagram of the radio frequency receiver in the present invention that applies radio frequency remote control device and method to find objects, the receiver 2 is mainly installed on an in-house appliance, and is consisted of:

a power supply device 22, which provide the necessary power for all other components of the radio frequency receiver so as to make the radio frequency receiver function correctly;

a low power detection circuit 23, which detect the power supply condition of the radio frequency receiver, if the power voltage is lower than the preset value, the detection circuit will activate the warning device 26;

reset key set 27, located on the outside of the radio frequency receiver, controlling the reset of the warning device;

a radio frequency receiver antenna 21, can receive the radio frequency signal from the radio frequency transmitter, and pass the signal to the receiving device 24;

a signal decoding device 25, which decodes the received signal and decides if the signal is correct;

warning device 26, comprising of visual indicator, a light emitting diode (LED), and the audible signal output. The audible signal sounds periodically to save the power and avoid the sound reflection from the wall or furniture. The sound reflection may cause the user to misjudge the source of the audible signal. When the decoding device 25 decodes the signal and decide there is no error in it, the warning device 26 will emit a continuous sound with flashing light, to enable the user to locate the object s/he is looking for. The warning signal will automatically reset when the preset timer expires, or when the reset key is pressed.

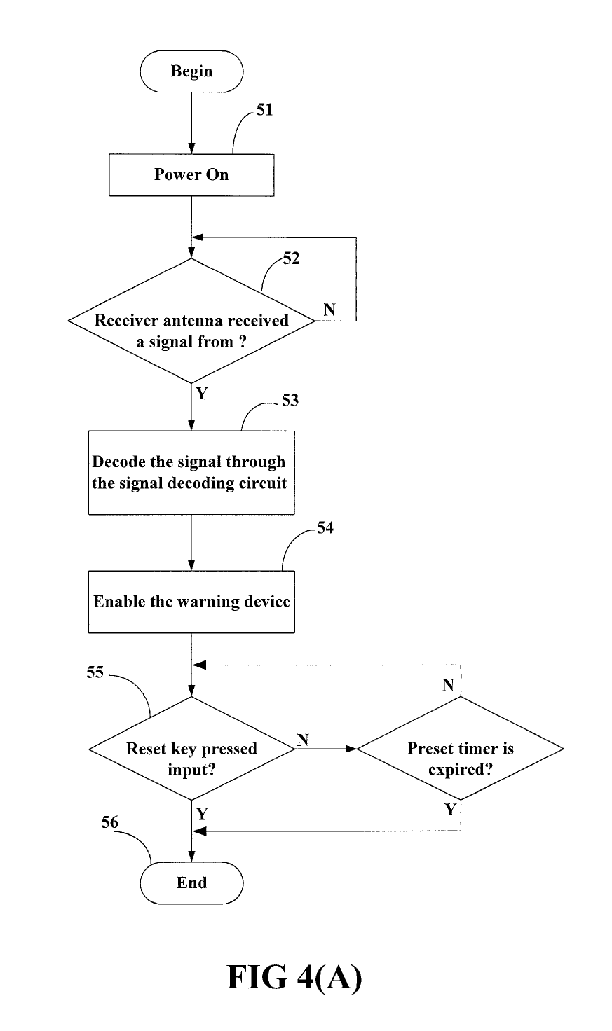

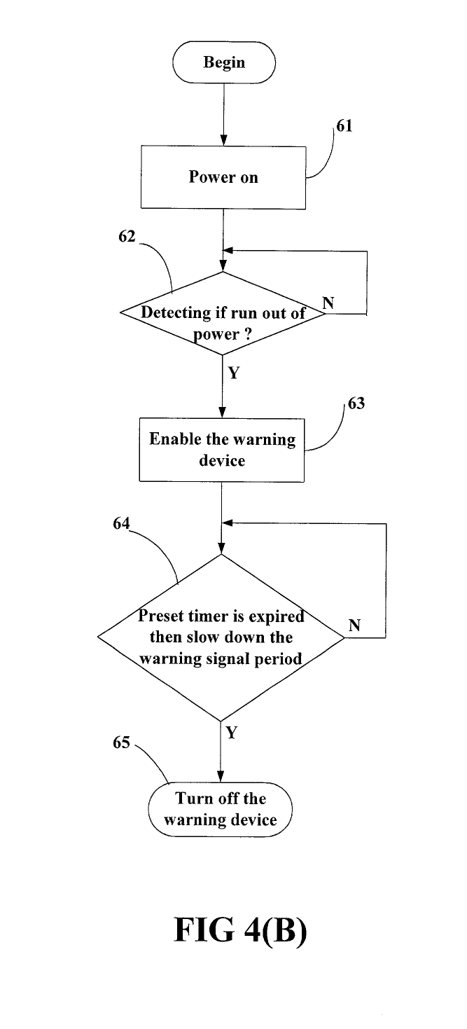

Please refer to FIG. 4A for the operation flow diagram which depicts the receiver of the present invention that applies radio frequency remote control device to find objects. When the power supply 51 of the receiver is on, it will begin to monitor to see if the receiver antenna has received radio signal(s) from the transmitter 52. If yes, the received signal will be passed to the receiving device, where it is decoded and verified for correctness in relations to an object of interest 53. If the signal is error-free, a warning device will emit a continuous audible and visible signal to remind the user the location of the object 54. The warning device will continuously monitor for the reset key-press instruction 55 while continuously emitting audible and visible signal for as long as there's no rest key-press or the preset timer has not expired. The warning device will turned off when either the reset key is pressed or the preset timer is expired and then, the radio frequency receiver will return to its standby condition 56.

Please refer to FIG. 4B for the low power detection flow diagram of the receiver in the present invention that applies radio frequency remote control device to find objects. When the power supply 61 of the radio frequency receiver is turned on, the low power detection device will begin to monitor the power level to see if it is lower than the preset value 62. If it is not, the detection circuit will continue to monitor the condition of power supply. If it is, the detection circuit will enable a warning device to function, and emit a continuous audible and visible signal to remind user that the power supply 63 needs to be replaced. The warning device will continue to send audible signal until the battery is replaced. If the preset timer is expired 64 and the battery is not replaced, these for the power saving reason, the warning device will slow down the audible signal warning period until the battery is replaced. When the battery is replaced, the warning signals will turn off and return to stand by condition 65.

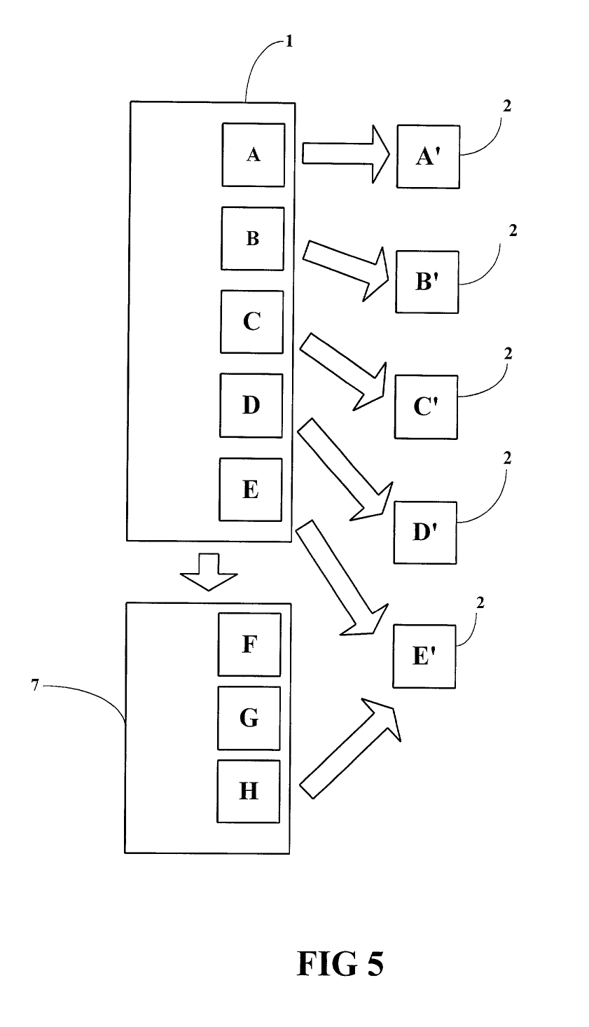

Please refer to FIG. 5 for the implementation diagram in the present invention that applies radio frequency remote control device and method to find objects. This invention can also make a radio frequency remote control learn the control code of the transmitter 1. The diagram shows the remote control 7 can learn the control code of key E of the radio frequency transmitter 1. After the remote control complete its learning process, the user can make this remote control 7 transmit same control code signal as the radio frequency transmitter 1 by press the key H. Hence, the radio frequency E′2 can receive both the signal from key E of the radio frequency transmitter 1 and the signal from key H of the remote control 7, and thus help the user find the object of interest through the remote control 7.

This invention provides a method and devices that apply radio frequency remote control device to find objects, when comparing with other conventional techniques in related field, the merits of this invention may be summarized as follows:

1. The radio frequency remote control of this invention is mainly mounted on at fixed position or is used with a burglar alarm. A receiver is installed on a house appliance or personal effect, such as emergency boxes, medicine cans, keys, and home electric device, etc. When the user forgets the location of the above said object s/he needs, according to the working principle of the radio frequency signal transmitting/receiving property, the user can use this invention to help and find the object quickly and thus avoid the looking-for object problem.

2. This invention has an internal timing device for users with special purpose such as a patient who requires regular, periodic medications. This application may be used to remind the patient the time to take medicine. The radio frequency remote control will transmit a radio signal for a receiver. The warning device in the receiver will then emit a continuous audible and/or visible signal to remind the patient to take the medicine. Meanwhile, to also help direct the patient to find the location of the medicine.

3. This invention also has a power-saving feature and is capable of operating for a long time, the size of its implementation is quite small hence takes no significant space.

Many changes and modifications in the above described embodiment of the invention can, of course, be carried out without departing from the scope thereof. Therefore, to promote the progress in science and the useful arts, the invention is disclosed and is intended to be limited only by the scope of the appended claims.

What is claimed is:

1. A method of applying radio frequency remote control device to find objects. By taking a button-press input from a button set, a radio frequency transmitter transmitting a coded signal according to instruction of the user's button-press input. The signal will be received by a radio frequency receiver which is connected to an object of the user's interest. Upon receiving the radio frequency signal, the said radio frequency receiver will decoding the radio frequency signal and emit audible and visible signals, showing the location of the object of the user's interest. Thus permitting the user to find the object quickly even in a dark environment.

2. The method of applying radio frequency remote control device to find objects according to claim 1. It is also capable of duplicating the codes of other radio frequency transmitter control devices. After the radio frequency transmitter completes its learning process, the user can use the duplicated radio frequency transmitter to transmit the same control code signal as the original radio frequency transmitter control device. The radio frequency receiver that is connected to the object can receive the coded signals from either the original radio frequency transmitter source or from the duplicated radio frequency transmitter source.

3. A device of applying radio frequency remote control device to find objects, comprising at least:
a radio frequency transmitter, mainly is composed of radio frequency transmitting device warning device low power detection circuit and radio frequency transmitter antenna;
a radio frequency receiver, mainly is composed of power supply device low power detection circuit warning device signal decoding device, receiving device and radio frequency receiver antenna;
The said coding signal generator of the said radio frequency transmitter device can generate a signal according to the button input instruction from the button set. The signal is passed to the transmitting device and transmitted through the radio frequency transmitter antenna. On the other side, the radio frequency signal is received by the said radio frequency receiver antenna of the said receiving device, then decoded by the said signal decoding device and judged if this signal has any error in it. If not, the said warning device in the said receiving device will emit a continuous or periodic audible and visible signal to help user find the object.

4. The device of applying radio frequency remote control device to find objects according to claim 3, wherein the said radio frequency transmitter is mounted at a fixed position.

5. The device of applying radio frequency remote control device to find objects according to claim 3, wherein the power supply of the said radio frequency transmitter provides power for all components in said radio frequency transmitter.

6. The device of applying radio frequency remote control device to find objects according to claim 3, wherein a timing device in the said radio frequency transmitter can be set up according to some timed event. When the time has come, the coding signal generator in the said radio frequency transmitter will generating a signal to a transmitting device in the said radio frequency transmitter and then transmitting the signal through an antenna. A receiving device in a radio frequency receiver on the other side will then receive the radio frequency signal. After correctly decoding and verifying by the said receiving device, a warning device in the said receiving device will then emit audible signal and visible signal to function as a reminder/warning.

7. The device of applying radio frequency remote control device to find objects according to claim 3, wherein the detection circuit of the said radio frequency transmitter is used for low power detection. When the power level of the radio frequency transmitter is lower than the preset value, the detection circuit will drive the warning device to function, reminding the user that the power supply needs to be replaced.

8. The device of applying radio frequency remote control device to find objects according to claim 7, wherein the warning device comprises a buzzer. The audible signal can be turned off by the button of the radio frequency transmitter, thus the warning device will not emit audible and visible signals forever.

9. The device of applying radio frequency remote control to find objects according to claim 3, wherein the power supply of the said radio frequency receiver provides power for all components in the said radio frequency receiver.

10. The device of applying radio frequency remote control device to find objects according to claim 3, wherein the detection circuit of the said radio frequency receiver is used for low power detection. When the power level of the radio frequency receiver is lower than the preset value, the detection circuit will drive the warning device to function, reminding the user that the power supply needs to be replaced.

11. The device of applying radio frequency remote control device to find objects according to claim 10, wherein the radio frequency signal receiver of the invention comprises of buzzer and light emitting diode (LED). The buzzer outputs a buzzing chirp periodically for saving the power and avoiding the sound reflection from the wall or furniture, since the sound reflection may causing the user to mistakenly judge the source of the buzzing chirp. During the operation of the radio frequency receiver, the warning device can be turned off by allowing the preset timer to expire, or by pressing a rest key of the radio frequency receiver. This avoids the power waste due to continuously or periodically emitting the audible and visible signal.

12. The device of applying radio frequency remote control device to find objects according to claim 3, wherein the radio frequency receiver of the invention can be installed on a daily in-house appliance, personal effects, as well as any specific object.
